(19) United States
(12) Patent Application Publication
(10) Pub. No.: US 2022/0268897 A1
(43) Pub. Date: Aug. 25, 2022

(54) DISTANCE MEASURING DEVICE

(71) Applicant: DENSO CORPORATION, Kariya-city (JP)

(72) Inventors: Akifumi UENO, Kariya-city (JP); Fumiaki MIZUNO, Kariya-city (JP); Yoshiaki HOASHI, Kariya-city (JP)

(21) Appl. No.: 17/663,091

(22) Filed: May 12, 2022

Related U.S. Application Data
(63) Continuation of application No. PCT/JP2020/041085, filed on Nov. 2, 2020.

(30) Foreign Application Priority Data
Nov. 13, 2019 (JP) 2019-205725
Oct. 15, 2020 (JP) 2020-173964

(51) Int. Cl. G01S 7/481; G01S 17/08; G01D 5/14

(52) U.S. Cl. CPC G01S 7/4817; G01S 17/08; G01D 5/14

(57) ABSTRACT

A distance measuring device includes a deflecting mirror configured to reflect transmission waves, and a swing motor configured to swing the deflecting mirror round a swing shaft so that scanning with the transmission waves is performed within a predetermined scanning region. The swing motor is configured to swing the deflecting mirror within a range of a predetermined rotation angle from a reference position, which is a rotational position of the deflecting mirror that reflects the transmission waves in a direction to a substantial center of the scanning region. The deflecting mirror is configured to return to the reference position when a distance measuring process, in which scanning with the transmission waves is repeated, ends.

### CROSS-REFERENCE TO RELATED APPLICATION

The present application is based on and claims the benefit of priority from earlier Japanese Patent Application No. 2019-205725 filed Nov. 13, 2019 and earlier Japanese Patent Application No. 2020-173964 filed Oct. 15, 2020, the descriptions of both of which are incorporated herein by reference.

### BACKGROUND

### Technical Field

The present disclosure relates to a distance measuring device including a deflecting mirror.

### Related Art

Distance measuring devices are known which transmit transmission waves to an object and detect reflected waves from the object, to detect a distance to the object and the like. This type of distance measuring device typically uses a deflecting mirror, which is rotated by a rotary motor, to perform scanning by deflecting the transmission waves.

### SUMMARY

As an aspect of the present disclosure, a distance measuring device is provided which includes: a deflecting mirror configured to reflect transmission waves; and a swing motor configured to swing the deflecting mirror round a swing shaft so that scanning with the transmission waves is performed within a predetermined scanning region. The swing motor is configured to swing the deflecting mirror within a range of a predetermined rotation angle from a reference position, which is a rotational position of the deflecting mirror that reflects the transmission waves in a direction to a substantial center of the scanning region. The deflecting mirror is configured to return to the reference position when a distance measuring process, in which scanning with the transmission waves is repeated, ends.

### BRIEF DESCRIPTION OF THE DRAWINGS

In the accompanying drawings:

FIG. 1 is a block diagram illustrating a configuration of a lidar device;

FIG. 2 is a schematic view of the lidar device viewed from the above;

FIG. 3 is a perspective view illustrating a schematic configuration of a light detection module;

FIG. 4 is a schematic sectional view of a swing motor cut along a plane orthogonal to a swing shaft;

FIG. 5 is an exploded perspective view illustrating a schematic configuration of an incremental encoder;

FIG. 6A is a schematic diagram of a deflecting mirror that rotates in a forward direction and a backward direction from a reference position;

FIG. 6B is a diagram illustrating pulse signals of the incremental encoder;

FIG. 7 is a diagram illustrating changes of a rotational position of the deflecting mirror, a voltage value, and the like in position adjustment control and scanning control;

FIG. 8 is a diagram illustrating changes of a rotational position of the deflecting mirror and the like in position restoration control; and

FIG. 9. is schematic view illustrating a position at which an optical window is provide, viewed from the above.

### DETAILED DESCRIPTION OF THE PREFERRED EMBODIMENTS

Distance measuring devices are known which transmit transmission waves to an object and detect reflected waves from the object, to detect a distance to the object and the like. This type of distance measuring device typically uses a deflecting mirror, which is rotated by a rotary motor, to perform scanning by deflecting the transmission waves.

Japanese patent No. 3949098 discloses a laser radar having a configuration for swinging (reciprocating) a moving part, which reflects a laser beam to perform scanning, by using an elastic body such as a plate spring and a torsion bar.

In a distance measuring device that swings (reciprocates) a deflecting mirror, after a position adjustment for adjusting a position of the deflecting mirror to a reference position is performed, scanning can be performed. Detailed studies by the inventor found a problem that the distance measuring device swinging (reciprocating) a deflecting mirror needs to be able to easily perform position adjustment for the deflecting mirror.

The present disclosure provides a distance measuring device that can easily perform position adjustment for a deflecting mirror.

Hereinafter, an exemplary embodiment of the present disclosure will be described with reference to the drawings.

### 1. Configuration

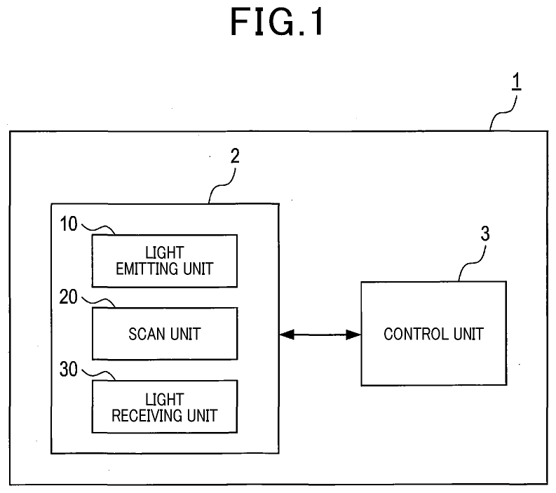

A lidar device 1 illustrated in FIG. 1 is a distance measuring device that illuminates an object with light and detects reflected light from the illuminated object to measure a distance to the object. The lidar device 1 is installed, for example, in a vehicle and is used to detect various objects present in front of the vehicle. The lidar is also denoted by LIDAR and is an abbreviation for Light Detection and Ranging.

The lidar device 1 includes a measurement unit 2 and a control unit 3.

The measurement unit 2 includes a light emitting unit 10, a scan unit 20, and a light-receiving unit 30.

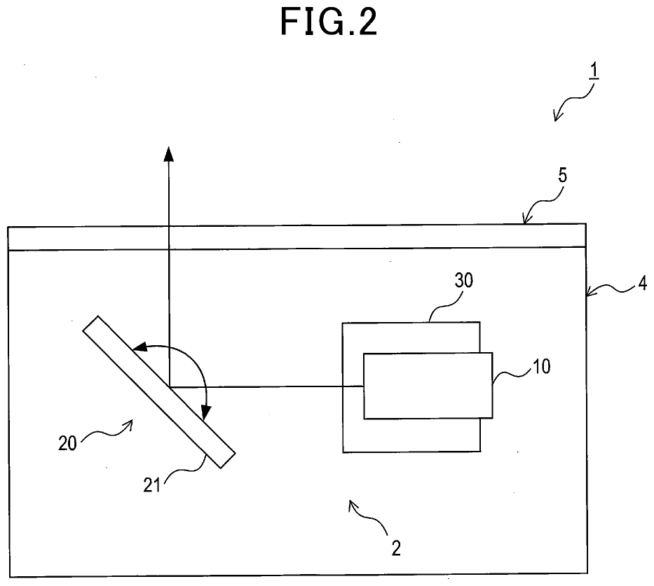

FIG. 2 is a schematic view of the lidar device 1 viewed from the above in the vertical direction in a state in which the lidar device 1 is installed in the vehicle. In FIG. 2, the upper direction is a scanning direction. In FIG. 2, the control unit 3 is omitted.

As illustrated in FIG. 2, the measurement unit 2 is accommodated in a housing 4. The housing 4 has a rectangular parallelepiped outer shape and is a resin case having one surface with an opening. The opening of the housing 4 is provided with a transparent optical window 5, through which light passes, so as to cover the whole opening. The light emitting unit 10 is accommodated in an upper internal space of the housing 4. The light-receiving unit 30 is accommodated in a lower internal space of the housing 4.

The light emitting unit 10 outputs a light beam intermittently.

The scan unit 20 includes a deflecting mirror 21 that is swung. The scan unit 20 causes the deflecting mirror 21 to reflect a light beam output from the light emitting unit 10 to emit the light beam in a direction depending on the rotational position of the deflecting mirror 21, thereby performing scanning with the light beam within a preset scanning region. The configuration of the scan unit 20 will be described in detail.

The light-receiving unit 30 receives reflected light from an object to which the light beam has been emitted, and converts the reflected light into an electric signal.

The control unit 3 illustrated in FIG. 1 uses the measurement unit 2 to measure a distance to the object from which the light beam has been reflected. Specifically, the control unit 3 specifies timing at which the reflected light is received based on a waveform of the electric signal output from the light-receiving unit 30 and obtains a distance to the object based on the difference between the specified timing and the timing at which the light beam is output. The control unit 3 can obtain information on the object, in addition to the distance, such as a direction in which the object is located.

The control unit 3 performs, in addition to the measurement of a distance, control of a swing motor (reciprocating motor) 22 described later.

### 2. Scan Unit

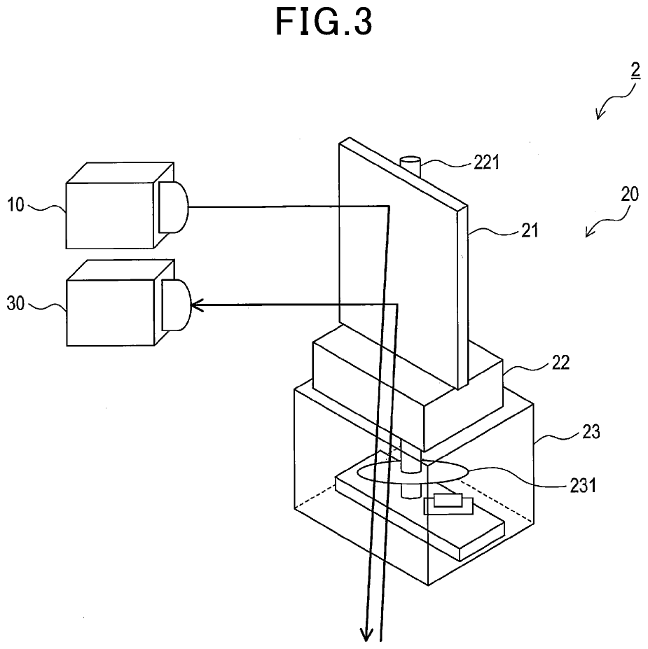

As illustrated in FIG. 3, the scan unit 20 includes the deflecting mirror 21, the swing motor 22, and an angular sensor 23.

The deflecting mirror 21 is a flat plate member having a reflection surface that reflects light. The deflecting mirror 21 is fixed to a swing shaft (reciprocating shaft) 221 described later of the swing motor 22 so as to move integrally with the swing shaft 221. In the present embodiment, an other surface, which is opposite to the reflection surface, of the deflecting mirror 21 is fixed to the swing shaft 221 so that the swing shaft 221 is along the central line of the other surface in the vertical direction.

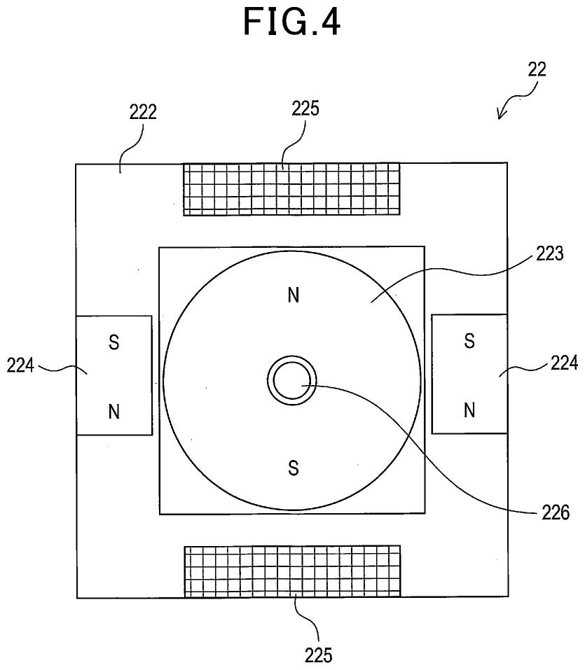

The swing motor 22 is disposed under the deflecting mirror 21 and swings (reciprocates) the deflecting mirror 21 around the swing shaft 221 so that scanning with a light beam can be performed within a predetermined scanning region. An internal structure and operation of the swing motor 22 of the present embodiment will be described with reference to FIG. 4.

As illustrated in FIG. 4, the swing motor 22 includes a case 222, a rotating magnet 223, two stationary magnets 224, a magnet coil 225, and a rotating shaft 226.

The rotating magnet 223 is a disk-shaped magnet having a shaft hole at the center position thereof. The rotating magnet 223 is supported by the rotating shaft 226 passing through the shaft hole so as to be rotatable in the case 222. The rotating magnet 223 is formed so that two poles are positioned in the direction perpendicular to the axial direction.

Each of the two stationary magnets 224 is fixed to the case 222 so that two poles are positioned in the direction perpendicular to the axial direction, specifically, so that the two poles are positioned in the vertical direction in FIG. 4. In the present embodiment, the stationary magnets 224 are disposed so that the south pole is on the upper side and the north pole is on the lower side.

A magnetic field of the rotating magnet 223 and magnetic fields of the two stationary magnets 224 interact with each other, whereby the rotating magnet 223 rests at a resting position at which the magnetic poles thereof are positioned in the direction opposite to those of the magnetic poles of the stationary magnets 224. FIG. 4 illustrates a case in which the rotating magnet 223 rests at the resting position. At the resting position, the north pole and the south pole of the rotating magnet 223 are respectively positioned on the upper side and the lower side in FIG. 4.

The magnet coil 225 is wound around the outer periphery of the case 222 in the vertical direction in FIG. 4. By energization, the magnet coil 225 generates lines of magnetic force having vertical components with respect to lines of magnetic force generated between the rotating magnet 223 and the two stationary magnets 224. The magnet coil 225 is connected to an AC power supply or a pulsed power supply.

When the swing motor 22 is in not energized, the rotating magnet 223 rests at the resting position illustrated in FIG. 4.

When the swing motor 22 is energized, that is, when the magnet coil 225 is energized, the magnet coil 225 generates lines of magnetic force having vertical components with respect to lines of magnetic force generated between the rotating magnet 223 and the two stationary magnets 224 from the magnet coil 225, whereby the rotating magnet 223 swings (reciprocates) around the resting position. The swing (reciprocation) is motion in which rotation in the forward direction and rotation in the backward (reverse) direction are periodically repeated within a range of a predetermined rotation angle less than 360°. In FIG. 4, the forward direction is a clockwise direction, and the backward direction is a counterclockwise direction. The clockwise direction and the counterclockwise direction in FIG. 4 agree with a clockwise direction and a counterclockwise direction when the lidar device 1 installed in a vehicle is viewed from above in the vertical direction. The rotating magnet 223 rotates in the forward direction from the resting position illustrated in FIG. 4 to a predetermined angle, and thereafter rotates in the backward direction. After returning to the resting position, the rotating magnet 223 rotates in the backward direction from the resting position to a predetermined angle. Thereafter, the rotating magnet 223 rotates in the forward direction again. After returning to the resting position, the rotating magnet 223 repeats the above operation. The angular range from the resting position in the forward direction is equal to the angular range from the resting position in the backward direction. On stopping of the energization of the swing motor 22, the rotating magnet 223 returns to the resting position by the magnetic force of the two stationary magnets 22 and rests.

The swing shaft 221 illustrated in FIG. 3 is formed so as to move integrally with the rotating magnet 223. That is, the swing shaft 221 rests at the resting position when the swing motor 22 is not energized, and swings (reciprocates) around the resting position when the swing motor 22 is energized.

The deflecting mirror 21 is fixed to the swing shaft 221 so that when the swing shaft 221 is at the resting position, the deflecting mirror 21 is at a reference, which is a rotational position at which a light beam is reflected to the substantial center of the scanning region. When the swing motor 22 is, the deflecting mirror 21 swings (reciprocates) associated with rotation of the swing shaft 221 within a range of a predetermined rotation angle from the reference position. On stopping of the energization of the swing motor 22, since the swing shaft 221 returns to the resting position, the deflecting mirror 21 returns to the reference position and rests. That is, when the swing motor 22 is not energized, the deflecting mirror 21 is biased in the direction in which the deflecting mirror 21 returns to the reference position.

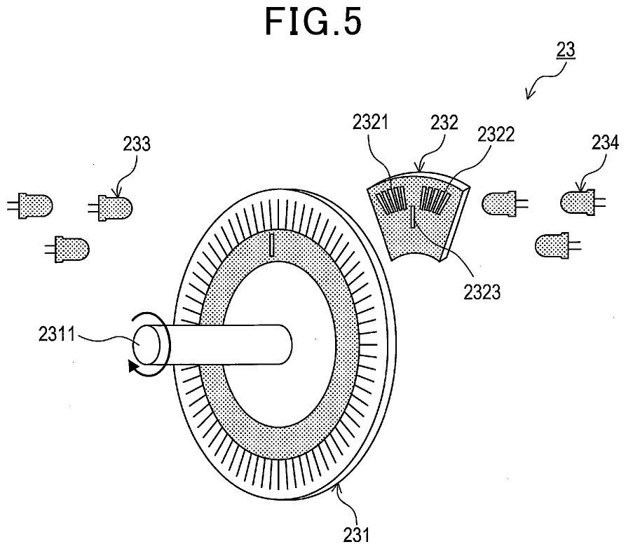

The angular sensor 23 is a sensor for detecting a rotation angle of the deflecting mirror 21. In the present embodiment, as the angular sensor 23, a well-known three-phase output type incremental encoder is used. As illustrated in FIG. 5, the angular sensor 23 includes a rotating disk 231, a fixed slit 232, a light-emitting element 233, and a light-receiving element 234.

The rotating disk 231 has a disk shape, an outer periphery part of which has a plurality of slits through which light passes. The rotating disk 231 has one slit, which indicates an origin position, on the inward side with respect to the plurality of slits located on the outer periphery part. A rotating shaft 2311 of the rotating disk 231 is fixed to the swing shaft 221 of the swing motor 22, whereby the rotating disk 231 moves integrally with the swing shaft 221.

The fixed slit 232 has three types of slits of an A-phase slit 2321, a B-phase slit 2322, and a Z-phase slit 2323 to make an output signal have three phases. The A-phase slit 2321 and the B-phase slit 2322 are formed at positions facing the plurality of slits of the outer periphery part of the rotating disk 231 so that the phase difference of the output signal between the A-phase and the B-phase is 90°. The Z-phase slit 2323 is formed at a position facing the slit indicating the origin position of the rotating disk 231.

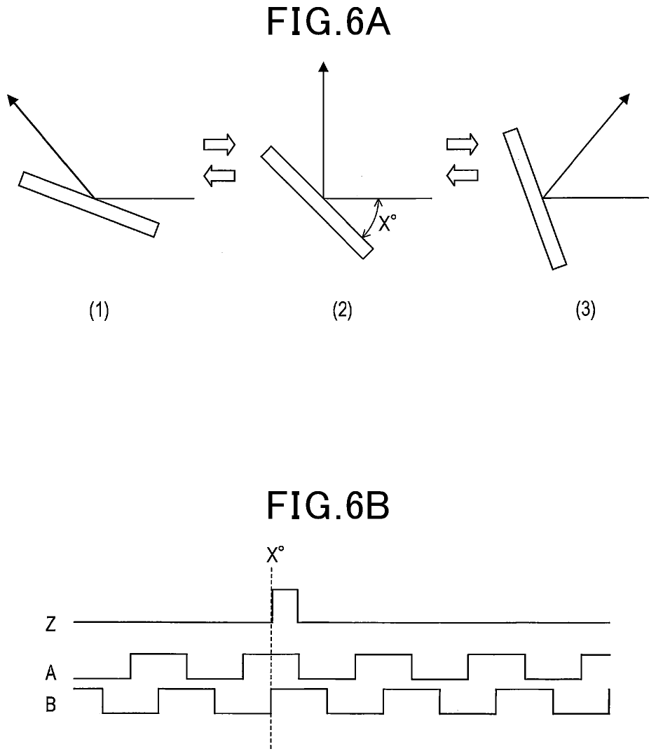

The light-emitting element 233 emits light toward the rotating disk 231. As the light-emitting element 233, for example, a light-emitting diode is used. The light-emitting element 233 and the light-receiving element 234 are disposed so as to face each other with the rotating disk 231 and the fixed slit 232 being interposed therebetween. The light-receiving element 234 receives light that has passed through the rotating disk 231 and the fixed slit 232 and, as illustrated in FIG. 6B, outputs A-phase, B-phase, and Z-phase pulse signals. As the light-receiving element 234, for example, a phototransistor is used.

The Z-phase signal is output once for each rotation of the rotating disk 231. The Z-phase signal is used as an origin signal. The A-phase signal and the B-phase signal are output with a phase difference of 90°. When the rotating disk 231 rotates in the forward direction, the B-phase signal is output with a delay of 90° with respect to the A-phase signal. When the rotating disk 231 rotates in the backward direction, the A-phase signal is output with a delay of 90° with respect to the B-phase signal. Hence, a rotational position with respect to the origin of the rotating disk 231 is detected based on waveforms of the A-phase signal and the B-phase signal after the Z-phase signal is detected.

FIG. 6A (1) to (3) is a schematic diagram of the deflecting mirror 21, which is at each rotational position, viewed from the above in the vertical direction in a state in which the lidar device 1 is installed in the vehicle. In FIG. 6A (1) to (3), the forward direction and the backward direction, which are directions of rotation, are the same as the forward direction and the backward direction in FIG. 4. As illustrated in FIG. 6A (2), the angular sensor 23 is placed to the swing motor 22 so that the Z-phase signal illustrated in FIG. 6B is output when the deflecting mirror 21 is at the reference position. That is, the rotating shaft 2311 of the rotating disk 231 is fixed to the swing shaft 221 so that the Z-phase signal is output when the swing shaft 221 is at the resting position. In FIG. 6A (2), an angle between the deflecting mirror 21 and a light beam output from the light emitting unit 10 at the reference position is defined as X°. In the present embodiment, X°=45°. FIG. 6B illustrates that the Z-phase signal is output when the angle between the deflecting mirror 21 and a light beam output from the light emitting unit 10 is X°.

As illustrated in FIG. 6A (1), when the deflecting mirror 21 has rotated in the backward direction from the reference position, the A-phase signal is output with a delay of 90° with respect to the B-phase signal as illustrated in FIG. 6B. As illustrated in FIG. 6A (3), when the deflecting mirror 21 has rotated in the forward direction from the reference position, the B-phase signal is output with a delay of 90° with respect to the A-phase signal as illustrated in FIG. 6B. Hence, the angular sensor 23 can detect a rotational position with respect to the reference position of the deflecting mirror 21 based on waveforms of the A-phase signal and the B-phase signal after the Z-phase signal is detected.

That is, the angular sensor 23 is configured to detect an origin position and a relative angle with respect to the origin position, as a rotational position of the deflecting mirror 21, and detects the reference position of the deflecting mirror 21 as the origin position.

### 3. Control Unit

The control unit 3 is configured to perform position adjustment control and scanning control as control for the swing motor 22.

Under the position adjustment control, after energization of the swing motor 22 starts, the swing motor 22 is moved so as to perform position adjustment of the deflecting mirror 21 based on a result of detection of the origin position by the angular sensor 23, specifically in the present embodiment, an incremental encoder. Hereinafter, in the description of the control unit 3, the angular sensor 23 is referred to as an incremental encoder that is an example thereof.

Under the scanning control, after the position adjustment is performed, the swing motor 22 is moved so as to perform scanning with a light beam by swinging (reciprocating) the deflecting mirror 21 within a range of a predetermined rotation angle from the reference position.

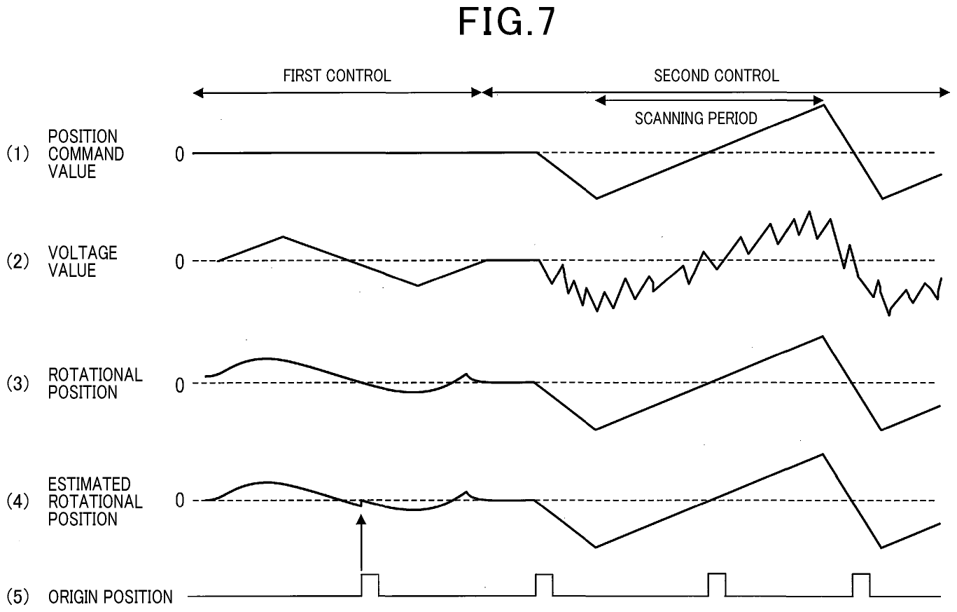

FIG. 7(3) illustrates a change of a practical rotational position of the deflecting mirror 21 in the position adjustment control and the scanning control. In FIG. 7(3), a case in which the deflecting mirror 21 is at the reference position is defined as 0°, a rotational position with respect to the reference position in a case in which the deflecting mirror 21 rotates in the forward direction is indicated by a positive value, and a rotational position with respect to the reference position in a case in which the deflecting mirror 21 rotates in the backward direction is indicated by a negative value. In the state in which the deflecting mirror 21 rotates in the forward direction, a rate of change of the rotational position, in other words, the gradient of a graph illustrated in FIG. 7(3) is positive. In the state in which the deflecting mirror 21 rotates in the backward direction, the gradient of the graph is negative. For example, when the deflecting mirror 21 swings (reciprocates) around the reference position within a range of a rotation angle of 60°, the rotational position of the deflecting mirror 21 changes within a range from +30° to −30°. At the time point at which the rotational direction of the deflecting mirror 21 is changed, the absolute value of the rotational position of the deflecting mirror 21 becomes maximum. Also, in FIGS. 7(1) and (4), the rotational position of the deflecting mirror 21 is indicated.

As illustrated in FIG. 7(3), the range of a change of the rotational position of the deflecting mirror 21 in the position adjustment control, that is, the width of a swing (reciprocation) of the deflecting mirror 21 is smaller than the width of a swing (reciprocation) of the deflecting mirror 21 in the scanning control.

Under the position adjustment control, after energization of the swing motor 22 starts, the control unit 3 swings (reciprocates) the deflecting mirror 21 so that the origin signal is detected by the incremental encoder. Since the deflecting mirror 21 is biased in the direction in which the deflecting mirror 21 returns to the reference position when the swing motor 22 is not energized, the deflecting mirror 21 is located in the vicinity of the reference position when energization of the swing motor 22 starts. Hence, swinging (reciprocating) the deflecting mirror 21 with a small width of swing (reciprocation) can detect the origin position by the incremental encoder, whereby the deflecting mirror 21 is not required to be swung with the same width of swing (reciprocation) as that when scanning is performed.

The control unit 3 is configured to determine a voltage value that is a value of a voltage applied to the swing motor 22. FIG. 7 (2) illustrates a change of the voltage value in the position adjustment control and the scanning control. In FIG. 7, a value of the voltage applied for rotating the deflecting mirror 21 in the forward direction is indicated by a positive value, and a value of the voltage applied for rotating the deflecting mirror 21 in the backward direction is indicated by a negative value.

The position adjustment control is open loop control that determines a voltage value by not using a result of detection by the incremental encoder. In the position adjustment control, for example, a voltage value is used which is preset so that the deflecting mirror 21 swings (reciprocates) with a predetermined width.

In the position adjustment control, position adjustment of the deflecting mirror 21 is performed as below. When energization of the swing motor 22 starts, the amount of displacement of the rotational position of the deflecting mirror 21 from the reference position is unclear. Hence, as illustrated in FIG. 7(4), the control unit 3 assumes that the deflecting mirror 21 is at the reference position when the energization starts and calculates an estimated rotational position of the deflecting mirror 21 based on the voltage value illustrated in FIG. 7(2). Thereafter, when the origin signal is detected by the incremental encoder, the control unit 3 calibrates the estimated rotational position of the deflecting mirror 21 to 0°, which is the reference position, as indicated by the arrow in FIG. 7(4). Thus, the control unit 3 adjusts the estimated rotational position of the deflecting mirror 21 to a practical rotational position, so that scanning can be performed.

The scanning control is feedback control that determines a voltage value based on a result of detection by the incremental encoder and a predetermined target angle. Under the scanning control, as illustrated in FIGS. 7(4) and (5), the control unit 3 calculates the estimated rotational position of the deflecting mirror 21 based on a result of detection of the rotational position of the deflecting mirror 21 by the incremental encoder. Then, the control unit 3 determines a voltage value based on the calculated estimated rotational position and a position command value illustrated in FIG. 7(1). The position command value is a value for instructing a rotational position of the deflecting mirror 21 so that a rotation angle with respect to the origin position becomes the predetermined target angle to perform scanning with a light beam. When the scanning with a light beam is performed, the target angle and the position command value related to the target angle change. The practical rotational position of the deflecting mirror 21 changes in accordance with the position command value as illustrated in FIGS. 7(1) and (3). The period indicated by the arrows during which the deflecting mirror 21 rotates in the forward direction is one scanning period. The width of swing (reciprocation) of the deflecting mirror 21 is the scanning region. For example, the width of swing (reciprocation) of the deflecting mirror 21 is +30° to −30°, the scanning period is 60°. Since the position adjustment control does not perform scanning with a light beam, the position command value is set to 0° in the position adjustment control because the position command value is not used.

The control unit 3 performs scanning control to perform a distance measuring process that repeats scanning with a light beam.

### 4. Effects

The embodiment described above provides the following effects.

(4a) The swing motor 22 swings (reciprocates) the deflecting mirror 21 within a range of a predetermined rotation angle from the reference position, which is a rotational position of the deflecting mirror 21 that reflects a light beam in the direction to the substantial center of the scanning region. When the swing motor 22 is not energized, the deflecting mirror 21 is biased in the direction in which the deflecting mirror 21 returns to the reference position. According to the configuration, compared with a configuration in which the deflecting mirror 21 does not return to the reference position when the swing motor 22 is not energized, the position adjustment for the deflecting mirror 21 can be easily performed, and time and electric power required for reaching a state in which scanning can be performed can be reduced.

Since the size of the angular range in which the deflecting mirror 21 rotates in the forward direction from the reference position is equal to the angular range in which the deflecting mirror 21 rotates in the backward direction from the reference position, peak electric power required for swinging (reciprocating) the deflecting mirror 21 can be reduced compared with a case in which the sizes of the two angular ranges are different from each other. The peak electric power is required for rotating the deflecting mirror 21 by the swing motor 22 to the rotational position at which the absolute value of the rotational position becomes maximum. For example, when the deflecting mirror 21 swings (reciprocates) within the same range of a rotation angle, the maximum value of the absolute value of the rotational position of the deflecting mirror 21 in a case in which the angular range in which the deflecting mirror 21 rotates in the forward direction is equal to the angular range in which the deflecting mirror 21 rotates in the backward direction is less than the maximum value of the absolute value of the rotational position of the deflecting mirror 21 in a case in which the two angular ranges are different from each other. Hence, if the two angular ranges are equal to each other, peak electric power required by the swing motor 22 is small compared with a case in which the two angular ranges are different from each other.

(4b) The swing motor 22 is configured so that the swing shaft 221 is biased in the direction in which the swing shaft 221 returns to the resting position, by the two stationary magnets 224 when the swing motor 22 is not energized. The deflecting mirror 21 is fixed to the swing shaft 221 so that the deflecting mirror 21 is at the reference position when the swing shaft 221 is at the resting position. According to the configuration, using the swing motor 22 having the above biasing force can return the deflecting mirror 21 to the reference position when the swing motor 22 is not energized.

(4c) The incremental encoder, which is an example of the angular sensor 23, is configured to detect, as a rotational position of the deflecting mirror 21, the origin position and a relative angle with respect to the origin position, and detects a reference position of the deflecting mirror 21 as the origin position. According to the configuration, since the deflecting mirror 21 is biased in the direction in which the deflecting mirror 21 returns to the reference position when the swing motor 22 is not energized, the origin position can be easily detected by the incremental encoder after energization of the swing motor 22 starts. Hence, time and electric power required for calibrating the estimated rotational position of the deflecting mirror 21 can be reduced. In addition, time and electric power required for reaching a state in which scanning can be performed can be reduced.

(4d) The control unit 3 is configured to perform the position adjustment control, which performs position adjustment of the deflecting mirror 21 after energization of the swing motor 22 starts, and the scanning control, which performs scanning with a light beam. The width of a swing (reciprocation) of the deflecting mirror 21 in the position adjustment control is smaller than the width of a swing (reciprocation) of the deflecting mirror 21 in the scanning control. According to the configuration, the width of a swing (reciprocation) of the deflecting mirror 21 does not become unnecessarily large when position adjustment of the deflecting mirror 21 is performed, whereby the position adjustment of the deflecting mirror 21 can be performed quickly with a small amount of swing (reciprocation).

(4e) The position adjustment control is open loop control that determines a voltage value, which is a value of a value applied to the swing motor 22, by not using a result of detection by the incremental encoder. The scanning control is feedback control that determines the voltage value based on a result of detection by the incremental encoder and a target angle of the process. If performing also the position adjustment control with feedback control, the control unit 3 determines a voltage value by using the estimated rotational position of the deflecting mirror 21. Hence, due to variation in the estimated rotational position when the estimated rotational position indicated by the arrow illustrated in FIG. 7(4) is calibrated, the determined voltage value becomes unstable. According to the present embodiment, the control unit 3 performs the position adjustment control with open loop control, thereby stabilizing the voltage value in the position adjustment control. In addition, the control unit 3 performs the scanning control with feedback control, thereby strictly controlling the rotational position of the deflecting mirror 21 when scanning is performed with a light beam.

In the present embodiment, a light beam corresponds to transmission waves, the optical window 5 corresponds to a transmission window, the two stationary magnets 224 correspond to a biasing unit, and the resting position corresponds to a predetermined position.

### 5. Other Embodiments

Although an embodiment of the present disclosure has been described, needless to say, the present disclosure is not limited to the above embodiment and includes various embodiments.

(5a) In the above embodiment, the deflecting mirror 21 is biased in the direction in which the deflecting mirror 21 returns to the reference position, by the two stationary magnets 224 included in the swing motor 22. However, the configuration for returning the deflecting mirror 21 to the reference position when the distance measuring process ends is not limited to the configuration in which the deflecting mirror 21 is biased by the two stationary magnets 224 so as to return to the reference position. For example, the control unit 3 may determine a value of voltage applied to the swing motor 22 so that the deflecting mirror 21 returns to the reference position after the distance measuring process ends. Alternatively, for example, the swing motor 22 may not include the two stationary magnets 224, and the deflecting mirror 21 may be biased by two stationary magnets provided outside the swing motor 22 so as to return to the reference position.

(5b) The control unit 3 may perform the position restoration control, for example, when the distance measuring process ends, regardless of presence or absence of the two stationary magnets 224. The position restoration control moves the swing motor 22 so as to return the deflecting mirror 21 to the reference position, and is the feedback control described above. In the position restoration control, the control unit 3 calculates the estimated rotational position of the deflecting mirror 21 as in the scanning control described above. Then, the control unit 3 determines a voltage value based on the calculated estimated rotational position and the position command value.

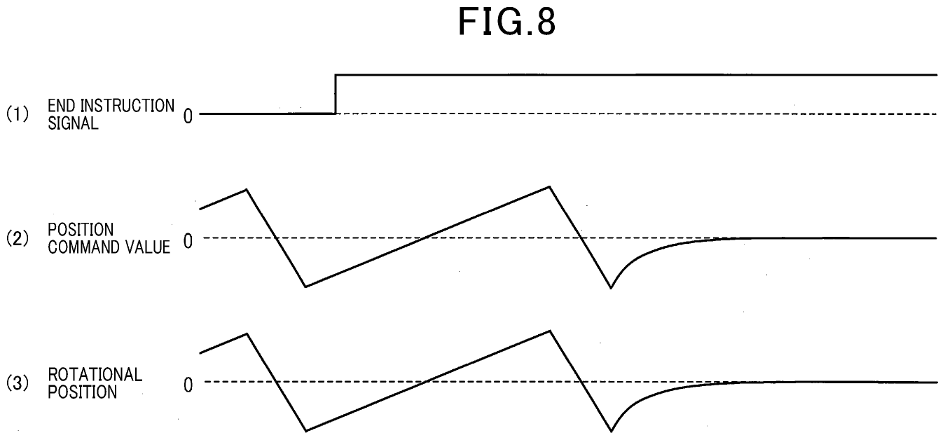

FIG. 8(2) illustrates of an example of a position command value in a case in which the distance measuring process is ended by an end instruction signal illustrated in FIG. 8(1), and the position restoration control is performed. The end instruction signal instructs the control unit 3 to end scanning with a light beam. For example, the end instruction signal is output from an ECU outside the lidar device 1 when the ignition switch of the vehicle is turned off. FIG. 8(2) exemplifies a position command value that changes, when the control unit 3 has detected the end instruction signal, the rotational position of the deflecting mirror 21 to the reference position after scanning with a light beam to a predetermined separation is performed. In FIG. 8(2), the separation is the timing at which, after the scanning period during which the end instruction signal is detected ends, a next scanning period starts due to reverse rotation of the deflecting mirror 21. FIG. 8(3) illustrates a practical rotational position of the deflecting mirror 21. As illustrated in FIG. 8(2)(3), in the position restoration control, the practical rotational position of the deflecting mirror 21 changes in accordance with the position command value and is returned to the reference position.

According to the above configuration, since the rotational position of the deflecting mirror 21 can be reliably returned to the reference position when the distance measuring process ends, the position adjustment of the deflecting mirror 21 can be reliably performed.

In the example illustrated in FIG. 8, when the end instruction signal is detected, the position restoration control is performed after the scanning with a light beam to the predetermined separation is performed. However, before the scanning reaches the separation, for example, immediately after the end instruction signal is detected, the scanning with a light beam may be ended to perform the position restoration control.

(5c) The lidar device 1 may further include an anomaly detection unit configured to detect an anomaly in the lidar device 1. When an anomaly in the lidar device 1 is detected, the anomaly detection unit may output the end instruction signal to the control unit 3.

(5d) In the above embodiment, the deflecting mirror 21 is biased in the direction in which the deflecting mirror 21 returns to the reference position by magnetic force of the two stationary magnets 224. However, the biasing force returning the deflecting mirror 21 to the reference position is not limited to magnetic force. For example, an elastic body such as a spring may be used to bias the deflecting mirror 21 so as to return to the reference position by elastic force by the elastic body.

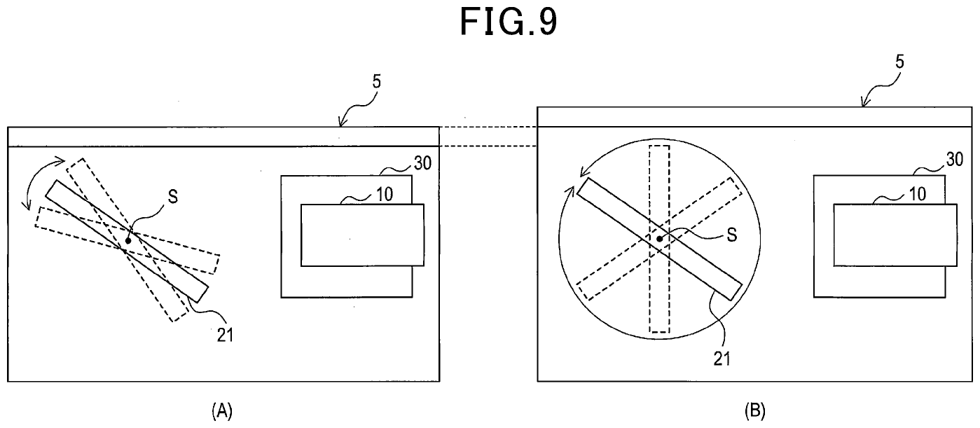

(5e) In the above embodiment, the housing 4 is provided with the optical window 5. The optical window 5 is provided at a swing (reciprocation) non-interference position of the housing 4. At the swing non-interference position, the optical window 5 does not interfere with the deflecting mirror 21 when the deflecting mirror 21 is swung. As illustrated in FIG. 9(A), the optical window 5 may be provided at a rotation interference position. At the rotation interference position, in the housing, the optical window 5 interferes with the deflecting mirror 21 assuming that the deflecting mirror 21 has rotated around the swing shaft 221 once. For example, when viewed along a rotation axis line S of the deflecting mirror 21, the rotation interference position may be set so that the shortest distance between the rotation axis line S and the optical window 5 is shorter than the longest length of the deflecting mirror 21 from the rotation axis line S. According to the configuration, compared with the configuration in which the optical window 5 is provided at a rotation non-interference position as illustrated in FIG. 9(B), the lidar device can be reduced in size. At the rotation non-interference position, in the housing, the optical window 5 does not interfere with the deflecting mirror 21 assuming that the deflecting mirror 21 has rotated around the swing shaft 221 once. FIG. 9(A)(B) is a schematic view of the lidar device viewed from the above in the vertical direction in a state in which the lidar device is installed in the vehicle.

(5f) In the above embodiment, although a configuration using an incremental encoder as the angular sensor 23 is exemplified, a sensor other than the incremental encoder may be used. The scan unit 20 may not include the angular sensor 23.

(5g) In the above embodiment, although the position adjustment control is open loop control, the position adjustment control may include control other than the open loop control. Furthermore, in the above embodiment, although the scanning control is feedback control, the scanning control may include control other than the feedback control.

(5h) The functions of a single component of the above embodiment may be distributed to a plurality of components. The functions of a plurality of components may be integrated into a single component. Furthermore, part of the configuration of the above embodiment may be omitted. Furthermore, at least part of the configuration of the above embodiment may be added to or replaced by another part of the configuration of the embodiment.

As an aspect of the present disclosure, a distance measuring device is provided which includes: a deflecting mirror (21) configured to reflect transmission waves; and a swing motor (22) configured to swing the deflecting mirror round a swing shaft (221) so that scanning with the transmission waves is performed within a predetermined scanning region. The swing motor is configured to swing the deflecting mirror within a range of a predetermined rotation angle from a reference position, which is a rotational position of the deflecting mirror that reflects the transmission waves in a direction to a substantial center of the scanning region. The deflecting mirror is configured to return to the reference position when a distance measuring process, in which scanning with the transmission waves is repeated, ends.

According to the above configuration, position adjustment for a deflecting mirror can be easily performed.

What is claimed is:

1. A distance measuring device, comprising:
a deflecting mirror configured to reflect transmission waves; and
a swing motor configured to swing the deflecting mirror round a swing shaft so that scanning with the transmission waves is performed within a predetermined scanning region; wherein
the swing motor is configured to swing the deflecting mirror within a range of a predetermined rotation angle from a reference position, which is a rotational position of the deflecting mirror that reflects the transmission waves in a direction to a substantial center of the scanning region, and
the deflecting mirror is configured to return to the reference position when a distance measuring process, in which scanning with the transmission waves is repeated, ends.

2. The distance measuring device according to claim 1, wherein
the swing motor includes a biasing unit configured to bias the swing shaft in a direction in which the swing shaft returns to a predetermined position, which is a predetermined rotational position of the swing shaft.

3. The distance measuring device according to claim 1, further comprising an incremental encoder configured to detect an origin position and a relative angle with respect to the origin position, as a rotational position of the deflecting mirror.

4. The distance measuring device according to claim 3, further comprising a control unit configured to control the swing motor, wherein
the control unit is configured to perform position adjustment control and scanning control,
Under the position adjustment control, after energization of the swing motor starts, the swing motor is moved so as to perform position adjustment of the deflecting mirror based on a result of detection of the origin position by the incremental encoder, and
Under the scanning control, after the position adjustment is performed, the swing motor is moved so as to perform scanning with the transmission waves by swinging the deflecting mirror within a range of a predetermined rotation angle from the reference position.

5. The distance measuring device according to claim 4, wherein
a width of a swing of the deflecting mirror in the position adjustment control is smaller than a width of a swing of the deflecting mirror in the scanning control.

6. The distance measuring device according to claim 4, wherein
the control unit is configured to determine a voltage value that is a value of a voltage applied to the swing motor,
the position adjustment control includes open loop control that determines the voltage value by not using a result of detection by the incremental encoder, and
the scanning control includes feedback control that determines the voltage value based on the result of detection by the incremental encoder and a predetermined target angle.

7. The distance measuring device according to claim 3, further comprising a control unit configured to determine a voltage value that is a value of a voltage applied to the swing motor to control the swing motor, wherein
the control unit is configured to, when the distance measuring process ends, perform position restoration control that moves the swing motor so as to return the deflecting mirror to the reference position, and
the position restoration control includes feedback control that determines the voltage value based on a result of detection by the incremental encoder and a predetermined target angle.

8. The distance measuring device according to claim 1, further comprising:
a housing configured to accommodate the deflecting mirror; and
a transmission window provided to the housing and configured to transmit the transmission waves reflected from the deflecting mirror, wherein
the transmission window is provided at a position, in the housing, at which the transmission window interferes with the deflecting mirror assuming that the deflecting mirror has rotated around the swing shaft once.
